(19) United States
(12) Patent Application Publication
(10) Pub. No.: US 2025/0224013 A1
(43) Pub. Date: Jul. 10, 2025

(54) METHOD FOR MANUFACTURING SLIDING MEMBER, METHOD FOR MANUFACTURING DAMPER, SLIDING MEMBER, DAMPER, AND METHOD FOR ADJUSTING RIDE COMFORT

(71) Applicant: KYB Corporation, Tokyo (JP)

(72) Inventor: Shinji Kato, Tokyo (JP)

(73) Assignee: KYB Corporation, Tokyo (JP)

(21) Appl. No.: 18/700,189

(22) PCT Filed: Oct. 13, 2022
(86) PCT No.: PCT/JP2022/038241

§ 371 Date: Apr. 10, 2024

(30) Foreign Application Priority Data
Oct. 22, 2021 (JP) 2021-172940

(51) Int. Cl. F16F 9/32; B24B 5/36; B60G 13/08

(52) U.S. Cl. CPC F16F 9/3221; B24B 5/36; B60G 13/08; B60G 2204/40; B60G 2206/41; B60G 2800/162; F16F 2226/02; F16F 2230/02; F16F 2230/04; F16F 2234/02

(57) ABSTRACT

Provided are a method for manufacturing a sliding member, a method for manufacturing a shock absorber, a sliding member, a shock absorber, and a method for adjusting ride comfort capable of improving retention of lubricating oil between sliding members while increasing operability and capable of sustaining smooth sliding of the sliding members. A method for manufacturing a sliding member that performs a sliding operation in a presence of a lubricating oil, the method having a first polishing step of polishing a surface of the sliding member in a circumferential direction of the sliding member by using a polishing tape having a first whetstone to form a plurality of grooves disposed around the sliding member in the circumferential direction; and a second polishing step of polishing the sliding member after the first polishing step to form a surface cross section in a longitudinal direction of the sliding member in a plateau shape.

### TECHNICAL FIELD

The present invention relates to a method for manufacturing a sliding member, a method for manufacturing a shock absorber, a sliding member, a shock absorber, and a method for adjusting ride comfort.

### BACKGROUND ART

In the related art, there is known a technique of mechanically polishing atn outer peripheral surface of a piston rod of a shock absorber to increase the operability of the shock absorber (for example, Patent Document 1).

### CITATION LIST

### Patent Document

Patent Document 1: Japanese Patent Application Laid-Open No. 2003-042208

### SUMMARY

### Technical Problem

However, in a case where the outer peripheral surface of the piston rod is mirror-finished in order to slide the piston rod in the shock absorber smoothly, squeeze-out may occur in which the lubricating oil that should be present between sliding members such as the piston rod and a seal member leaks from between the sliding members and the lubricating oil is not capable of being retained between the sliding members (or an oil pool). Therefore, there has been a demand for a sliding member or a shock absorber capable of improving the retention of the lubricating oil between the sliding members while increasing operability, thereby sustaining the smooth sliding of the sliding members.

The present invention provides a method for manufacturing a sliding member, a method for manufacturing a shock absorber, a sliding member, a shock absorber, and a method for adjusting ride comfort capable of improving retention of lubricating oil between sliding members while increasing operability and capable of sustaining smooth sliding of the sliding members.

### Solution to Problem

The gist of the present invention is methods for manufacturing a sliding member in the following (1) to (7).
(1) A method for manufacturing a sliding member that performs a sliding operation in a presence of a lubricating oil, the method including: a first polishing step of polishing a surface of the sliding member in a circumferential direction of the sliding member by using a polishing tape having a first whetstone to form a plurality of grooves disposed around the sliding member in the circumferential direction; and a second polishing step of polishing the sliding member after the first polishing step to form a surface cross section in a longitudinal direction of the sliding member in a plateau shape.
(2) The method for manufacturing a sliding member set forth in the above (1), in which an average particle diameter of the first whetstone is 15 to 100 μm.
(3) The method for manufacturing a sliding member set forth in the above (1) or (2), in which in the second polishing step, the sliding member is polished in the circumferential direction by using a polishing tape having a second whetstone with a smaller average particle diameter than the first whetstone.
(4) The method for manufacturing a sliding member set forth in any one of the above (1) to (3), in which an average particle diameter of the second whetstone is 0.1 to 12 μm.
(5) The method for manufacturing a sliding member set forth in any one of the above (1) to (4), in which in the first polishing step, the polishing tape is fed while the sliding member is turned by a lathe, and the polishing tape is brought into contact with the sliding member to polish the sliding member, and a feeding speed of the polishing tape is 1/10 or less of a turning speed of the sliding member.
(6) The method for manufacturing a sliding member set forth in any one of the above (1) to (5), in which in the first polishing step, the polishing tape is fed while the sliding member is turned by a lathe, and the polishing tape is brought into contact with the sliding member to polish the sliding member, and a relative movement speed between the sliding member and the polishing tape in the longitudinal direction of the sliding member is 1/100 or less of a turning speed of the sliding member.
(7) The method for manufacturing a sliding member set forth in any one of the above (1) to (5), in which in the first polishing step, oscillation of reciprocating the polishing tape in the longitudinal direction of the sliding member is not performed.

The gist of the present invention is a method for manufacturing a shock absorber in the following (8).
(8) A method for manufacturing a shock absorber, in which a sliding member of the shock absorber is manufactured by using the method for manufacturing a sliding member set forth in any one of the above (1) to (7).

The gist of the present invention is sliding members in the following (9) or (10).
(9) A cylindrical sliding member that performs a sliding operation in a presence of a lubricating oil, in which a plurality of grooves disposed around in a circumferential direction is provided on a surface of the sliding member, and a surface cross section in the longitudinal direction of the sliding member is formed in a plateau shape.
(10) The sliding member set forth in the above (9) above, in which a load length ratio (tp) in the longitudinal direction is 50% or more.

The gist of the present invention is a shock absorber in the following (11).
(11) A shock absorber including the sliding member set forth in the above (9) or (10).

The gist of the present invention is a method for adjusting ride comfort in the following (12).
(12) A method for adjusting ride comfort including: when a sliding member used for the shock absorber of the moving object is polished, polishing the sliding member such that a surface cross section in a longitudinal direction has a plateau shape; and adjusting a load length ratio (tp) in the longitudinal direction to adjust a ride comfort of the moving object using the shock absorber.

### Advantageous Effects of Invention

According to the present invention, it is possible to provide the method for manufacturing a sliding member, the method for manufacturing a shock absorber, the sliding member, the shock absorber, and the method for adjusting ride comfort capable of improving retention of the lubricating oil between the sliding members while increasing operability and capable of sustaining smooth sliding of the sliding members.

### BRIEF DESCRIPTION OF DRAWINGS

FIG. 1 is a view for describing a tape polishing device according to the present invention.

FIG. 2 is a view in which a piston rod polished by a polishing method according to the present embodiment is measured using a laser-type surface roughness measuring instrument and the measurement results are visualized.

FIG. 3 is a conceptual view for describing grooves formed in a sliding member according to the present embodiment.

FIG. 4 is a schematic view for describing a surface cross section of the sliding member according to the present embodiment in a longitudinal direction.

FIG. 5 is a view illustrating results obtained by tape-polishing a piston rod of a shock absorber by the polishing method according to the present embodiment and by measuring the surface roughness using the laser-type surface roughness measuring instrument.

FIG. 6 is a view illustrating results obtained by polishing Bauden test pieces having a chromium-plated surface with a polishing tape under predetermined polishing conditions and by measuring the surface roughness using the laser-type surface roughness measuring instrument.

FIG. 7 is a graph obtained by plotting a relationship between a load length ratio (tp) and the number of one-point arrival times in test examples (B), and (D) to (G).

FIG. 8 is a view for describing a relationship between a plateau shape and ride comfort.

FIG. 9 is a view for describing an amplitude-dependent index.

### DESCRIPTION OF EMBODIMENTS

The present invention relates to a method for manufacturing a sliding member that repeats the sliding operation (particularly sliding operation in a reciprocating direction) of a piston rod or the like used in a shock absorber of a vehicle in the presence of lubricating oil. In the related art, when manufacturing the sliding member, in order to smooth the sliding operation of the sliding member, the surface of the sliding member is mechanically polished. However, in a case where the surface of the sliding member is mirror-finished, there is a case where squeeze-out occurs in which the lubricating oil interposed between the sliding member and a mating member leaks to the outside due to the sliding operation. In the present embodiment, a method for manufacturing the sliding member capable of smoothing the sliding operation of the sliding member and suppressing the occurrence of the squeeze-out will be described using the piston rod of the shock absorber as an example of the sliding member.

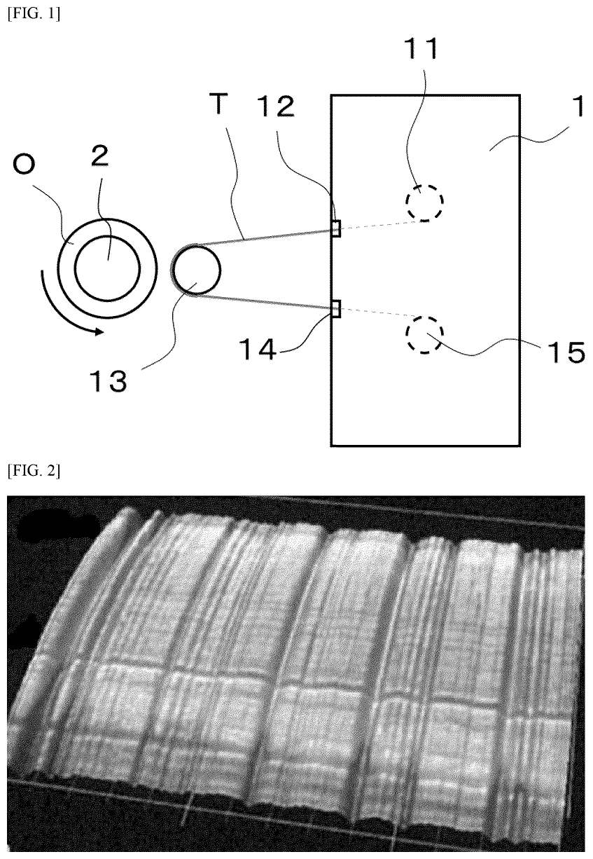

In the method for manufacturing the piston rod according to the present embodiment, when an outer peripheral surface of a tubular piston rod is mechanically polished, two-stage polishing is performed. Other than that, the piston rod is capable of being manufactured by a known method. Specifically, a piston rod having grooves disposed around the piston rod in the circumferential direction and having a surface cross section in a longitudinal direction formed in a plateau shape is capable of being manufactured as illustrated in FIG. 2 by polishing the piston rod in two stages with different types of polishing tape in the circumferential direction of the piston rod by using a tape polishing device 1 illustrated in FIG. 1. FIG. 1 is a configuration view illustrating the tape polishing device 1 according to the present embodiment. In addition, FIG. 2 is a view in which the piston rod polished by the polishing method according to the present embodiment is measured using a laser-type surface roughness measuring instrument and the surface roughness of the piston rod is visualized.

First, the tape polishing device 1 according to the present embodiment will be described. As illustrated in FIG. 1, the tape polishing device 1 according to the present embodiment has a feeding motor 11 for feeding a polishing tape T, a feeding port 12 for the polishing tape T, a roller 13 for pressing the polishing tape T against a piston rod O, a winding port 14 for the polishing tape T, and a winding motor 15 for winding the polishing tape.

In the present embodiment, the piston rod O is set on a lathe 2 and the tape polishing device 1 is disposed on a side of the piston rod O. Then, while the piston rod O is turned in the circumferential direction on the lathe 2, the roller 13 is moved to the piston rod O side, so that the polishing tape T wound on the roller 13 is capable of being brought into contact with a side surface of the piston rod O and the piston rod O is capable of being polished in the circumferential direction with the polishing tape T. It is preferable that the roller 13 is, for example, a roller made of an elastic resin such as urethane rubber. This is because, by making the roller 13 of the elastic resin having elasticity, the polishing tape T and the piston rod O are capable of being brought into contact with each other in a wide range. The hardness of the roller 13 is not particularly limited but in the present embodiment, a roller having a shore A hardness of 90 or HS90 is used. However, the hardness of the roller 13 is not limited to this, and for example, it is also possible to adopt a configuration in which a roller having a shore A hardness of 30 to 70 or a roller having HS30 to HS70 is used. In addition, it is possible to adopt a configuration in which the roller 13 is changed in a first polishing step and a second polishing step. In this case, it is possible to adopt a configuration in which the hardness of the roller 13 used in the first polishing step is higher than that in the second polishing step.

In addition, in the present embodiment, as will be described below, the piston rod O is polished by the polishing tape T while the polishing tape T is slowly moved in the longitudinal direction of the piston rod O. However, the piston rod O is capable of being uniformly polished by winding the polishing tape T from the winding port 14 with the winding motor 15 while feeding the polishing tape T from the feeding port 12 with the feeding motor 11 at any time in order to prevent non-uniformity of the degree of polishing of the piston rod O caused by the wear of a polishing surface of the polishing tape T. In particular, the piston rod O is capable of being uniformly polished by making the feeding speed of the polishing tape T faster than the movement speed of the polishing tape T in the longitudinal direction of the piston rod O.

In addition, in the present embodiment, the piston rod O is polished in two stages using two types of polishing tapes T1 and T2. Specifically, in a first-stage polishing, a first polishing step of polishing the piston rod O using the first polishing tape T1 having a whetstone with a larger average particle diameter than the second polishing tape T2 used in a second-stage polishing is performed. The first polishing tape T1 is not particularly limited as long as the average particle diameter of the whetstone is larger than that of the second polishing tape T2. For example, it is possible to use a polishing tape having a whetstone with an average particle diameter of 15 μm to 100 μm, more preferably a whetstone with an average particle diameter of 30 μm to 80 μm, and still more preferably a whetstone with an average particle diameter of 60 μm to 80 μm. In addition, the size of the whetstone may be defined by “particle size” instead of “average particle diameter” of the whetstone. In this case, the first polishing tape T1 may be a tape having a whetstone with a smaller particle size than that of the second polishing tape T2. For example, it is possible to use a tape having a particle size of 1000 to 120, and more preferably a whetstone having a particle size of 400 to 150.

In the first polishing step, by polishing the piston rod O in the circumferential direction using the first polishing tape T1, as illustrated in FIG. 2, the grooves disposed around in the circumferential direction are formed in the piston rod O. In the first polishing step, the turning speed of the piston rod O is not particularly limited but may be, for example, a rotational speed of 1000 rpm to 3000 rpm. On the other hand, the feeding speed of the first polishing tape T1 is set to a speed slower than the turning speed of the piston rod O, preferably a speed of 1/10 or less of the turning speed of the piston rod O and more preferably a speed of 1/100 or less of the turning speed of the piston rod O. This is because there is a case where, when the feeding speed of the first polishing tape T1 is set to be approximately the same as the turning speed of the piston rod O, the position (position in the longitudinal direction) of the whetstone may be changed before the piston rod O makes one rotation and it is not possible to form the grooves disposed around the piston rod O in the circumferential direction as illustrated in FIG. 2. Thus, by setting the feeding speed of the first polishing tape T1 to be slower than the turning speed of the piston rod O, it is possible to form the grooves disposed around the piston rod O in the circumferential direction, as illustrated in FIG. 2.

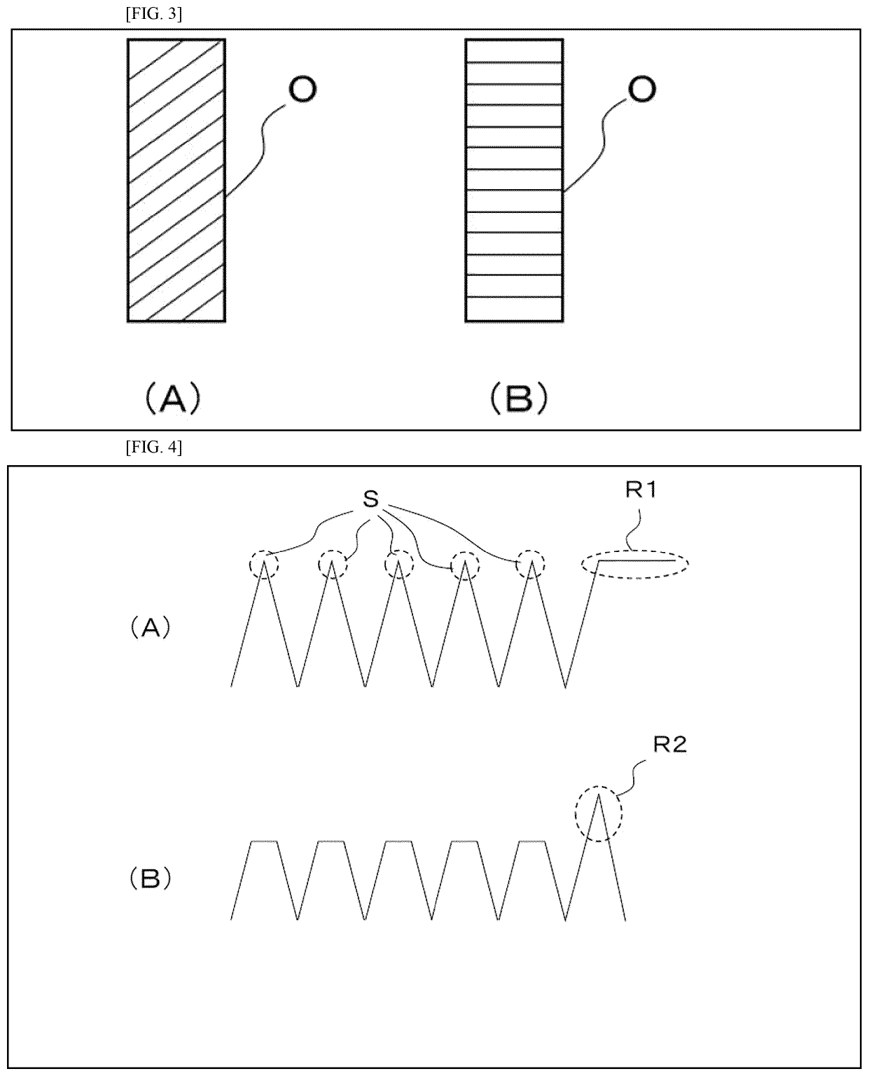

Moreover, in the first polishing step, the speed at which the first polishing tape T1 is moved in the longitudinal direction of the piston rod O is set to 1/100 or less, more preferably 1/1,000 or less of the turning speed of the piston rod O. In addition, in the first polishing step, no oscillation is also performed in which the first polishing tape 1T is reciprocated in the longitudinal direction of the piston rod O in order to smooth the polishing surface. In this way, by performing the first polishing step, it is possible to form the grooves disposed around in the circumferential direction as illustrated in FIG. 2 or (B) of FIG. 3 in the piston rod O instead of spiral (diagonal direction) grooves as illustrated in (A) of FIG. 3, and it is possible to suppress the occurrence of the squeeze-out. That is, as illustrated in (A) of FIG. 3, in a case where the spiral grooves are formed in the piston rod or in a case where the piston rod is mirror-surfaced, the lubricating oil may leak out to the outside between sliding members (or an oil pool) by moving along the spiral grooves or over the mirror finished surface. On the other hand, as illustrated in FIG. 2 or (B) of FIG. 3, by forming the grooves disposed around the piston rod O in the circumferential direction, the lubricating oil is capable of being accumulated in the grooves disposed around the piston rod O in the circumferential direction, and the lubricating oil is capable of being retained between the sliding members (or in the oil pool). In addition, in the above-described example, a configuration in which the first polishing tape T1 is moved in the longitudinal direction of the piston rod O is exemplified. However, the present invention is not limited to this, and a configuration may be adopted in which the piston rod O is moved in the longitudinal direction of the piston rod O with the position of the first polishing tape T1 fixed. Also in this case, it is preferable that the relative movement speed between the first polishing tape T1 and the piston rod O in the longitudinal direction of the piston rod O is set to 1/100 or less, more preferably 1/1000 or less of the turning speed of the piston rod O.

In addition, in the second-stage polishing, the second polishing step of polishing the piston rod O using the second polishing tape T2 is performed. The second polishing tape T2 is a polishing tape having a whetstone with an average particle diameter smaller than that of the first polishing tape T1. The second polishing tape T2 is also not particularly limited as long as the average particle diameter of the whetstone is smaller than that of the first polishing tape T1. For example, it is possible to use a polishing tape having a whetstone with an average particle diameter of 0.1 μm to 12 μm. In addition, similar to the first polishing tape T1, the size of the whetstone of the second polishing tape T2 is capable of being defined by the particle size. In this case, the second polishing tape T2 may be a tape having a whetstone with a larger particle size than the first polishing tape T1. For example, it is possible to use a tape having a whetstone with a particle size of 20,000 to 1,500. In the present invention, as the “average particle diameter” or “particle size” of the first polishing tape T1 or the second polishing tape T2, it is possible to use the “average particle diameter” or “particle size” defined in commercially available polishing tapes.

In the second polishing step, the piston rod O is polished using the second polishing tape T2 having a whetstone with an average particle diameter smaller than that of the first polishing tape T1, so that, as illustrated in (B) of FIG. 4, the surface cross section of the piston rod O in the longitudinal direction is capable of being formed in a plateau shape (trapezoidal shape). Here, FIG. 4 is a schematic view for describing the surface cross section of the piston rod according to the present embodiment in the longitudinal direction, and (A) of FIG. 4 is a schematic view illustrating a surface cross section of the piston rod in the longitudinal direction after the first polishing step of polishing the piston rod with the first polishing tape T1, and (B) of FIG. 4 is a schematic view illustrating a surface cross section of the piston rod in the longitudinal direction after the second polishing step T of polishing the piston rod with the second polishing tape T2. As illustrated in (A) of FIG. 4, in the first polishing step, chevron-shaped irregularities (irregularities with a sharp tip portion) are capable of being formed in the longitudinal direction of the piston rod O by polishing the piston rod O in the circumferential direction of the piston rod O using the first polishing tape T1 having a whetstone with a large average particle diameter. Then, in the second polishing step, the piston rod is polished with the second polishing tape T2, whereby the average particle diameter of the whetstone of the second polishing tape T2 is smaller than that of the first polishing tape T1. Therefore, it is possible to polish peak portions S on the surface of the piston rod O after the first polishing step. As a result, as illustrated in (B) of FIG. 4, the peak portions S on the surface of the piston rod are cut off, and the surface cross section in the longitudinal direction is formed in a plateau shape (trapezoidal shape). In addition, R1 in (A) of FIG. 4 indicates a portion of the piston rod before the first polishing step, and R2 in (B) of FIG. 4 indicates a portion of the piston rod after the first polishing step and before the second polishing step.

The second polishing step is not intended to form the grooves which are disposed around in the circumferential direction, unlike the first polishing step. Therefore, the second polishing tape T2 may not be polished in the circumferential direction of the piston rod, unlike the first polishing step. For example, it is possible to adopt a configuration in which the oscillation is performed in the longitudinal direction of the piston rod O and the polishing is performed in the longitudinal direction of the piston rod O. On the contrary, also in the second polishing step, similar to the first polishing step, it is possible to adopt a configuration in which the piston rod O is polished in the circumferential direction of the piston rod O by using the second polishing tape T2. In addition, also in the second polishing step, a configuration may be adopted in which the second polishing tape T2 is moved in the longitudinal direction of the piston rod O, or a configuration may be adopted in which the piston rod O is moved in the longitudinal direction of the piston rod O with the position of the second polishing tape T2 fixed. Also in this case, it is preferable that the relative movement speed between the second polishing tape T2 and the piston rod O in the longitudinal direction of the piston rod O is set to 1/100 or less, more preferably 1/1,000 or less of the turning speed of the piston rod O.

In addition, in the second polishing step, similar to the first polishing step, it is possible to exhibit the following effects by performing the polishing using the polishing tape. That is, even in a case where the “undulation” occurs on the polishing surface of the piston rod O in the first polishing step, in the second polishing step, the second polishing tape T2 is pressed against the piston rod O polished in the first polishing step by the roller 13 which is a rubber roller. Accordingly, since the second polishing tape T2 is capable of being changed into a shape suitable for the “undulation” to polish the piston rod O, it is possible to uniformly polish the piston rod O with the second polishing tape T2.

In addition, in the second polishing step, it is also possible to adopt a configuration in which the polishing is performed without using a polishing tape as long as a method capable of changing the chevron-shaped irregularities illustrated in (A) of FIG. 4 to plateau-shaped irregularities illustrated in (B) of FIG. 4 is provided. In this case, it is possible to adopt a configuration in which polishing using an elastic whetstone such as rubber or a sponge or buff polishing using a polishing cloth or the like is performed.

In the present embodiment, after the first polishing step is completed, the first polishing tape T1 is removed from the tape polishing device 10 and the second polishing tape T2 is attached to the tape polishing device 10 to execute the second polishing step. However, the present invention is not limited to the above method. For example, it is also possible to adopt a configuration in which two tape polishing devices 10 including a tape polishing device 10 to which the first polishing tape T1 is attached and a tape polishing device 10 to which the second polishing tape T2 is attached are disposed side by side and in which the piston rod O is polished by the tape polishing device 10 to which the first polishing tape T1 is attached and then continuously polished by the tape polishing device 10 to which the second polishing tape T2 is attached.

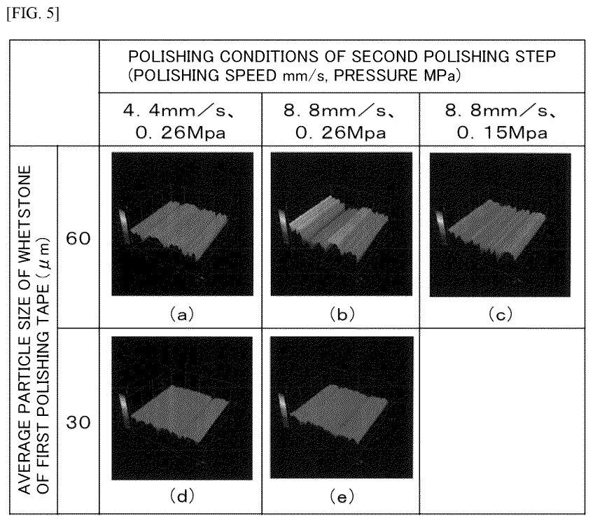

Next, examples of the present invention will be described. FIG. 5 is a view illustrating results obtained by tape-polishing the piston rod of the shock absorber by the polishing method according to the present embodiment and by measuring the surface roughness using the laser-type surface roughness measuring instrument. For example, in an example illustrated in (a) of FIG. 5, the first polishing step was performed using the first polishing tape T1 with an average particle diameter of 60 μm, and then the second polishing step was performed at a polishing speed of 4.4 mm/s and a polishing pressure of 0.26 MPa by using the second polishing tape T2 with an average particle diameter of 3 μm. The above “polishing speed” is the speed at which the second polishing tape T2 is moved in the longitudinal direction of the piston rod. The faster the polishing speed, the faster the polishing position of the piston rod changes and the number of times of polishing at the same position of the piston rod O is reduced. Similarly, in examples illustrated in (b) to (e) of FIG. 5, the first polishing step was performed using the first polishing tape T1 with an average particle diameter of 60 μm or an average particle diameter of 30 μm, and then the tape polishing was performed at a polishing speed of 4.4 mm/s or 8.8 mm/s and a polishing pressure of 0.26 MPa or 0.15 MPa by using the second polishing tape T2 with an average particle diameter of 3 μm. From the measurement results of the surface roughness illustrated in FIG. 5, it can be seen that, by performing the second polishing step using the second polishing tape T2 after the first polishing step using the first polishing tape T1, as illustrated in (B) of FIG. 4, the surface cross section in the longitudinal direction is capable of being formed in a plateau shape. In addition, it can be seen that, by changing the size of the whetstone of the first polishing tape T1 or the polishing speed and the polishing pressure in the second polishing step, the plateau shape (for example, the depth of the grooves, the size of the planar portions, the load length ratio (tp), and the like) of the polishing surface of the sliding member is capable of being changed.

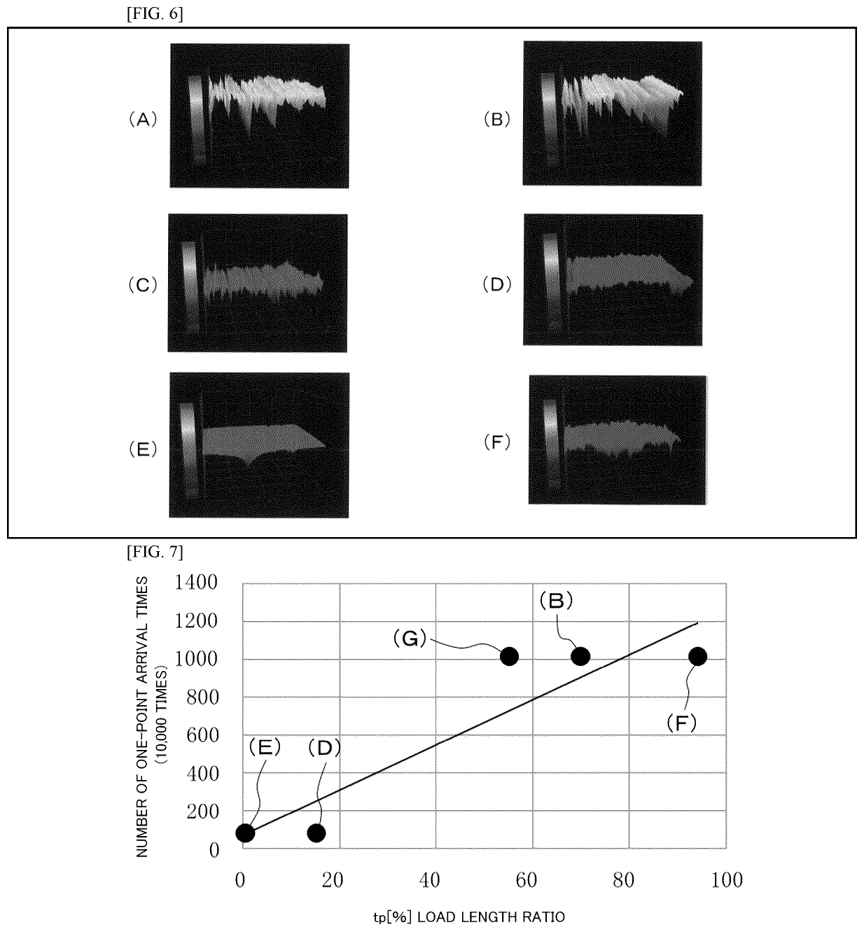

Moreover, FIG. 6 shows results obtained by polishing Bauden test pieces each having a chromium-plated surface with a polishing tape under the following polishing conditions shown below and by measuring the surface roughness using the laser-type surface roughness measuring instrument. That is, an example illustrated in (A) of FIG. 6 is an example in which only the first polishing step was performed using the first polishing tape T1 with an average particle diameter of 60 μm, and an example illustrated in (B) of FIG. 6 is an example in which the first polishing step was performed using the first polishing tape T1 with an average particle diameter of 60 μm and then the second polishing step was performed using the second polishing tape T2 with an average particle diameter of 3 μm. In addition, an example illustrated in (C) of FIG. 6 is an example in which only the first polishing step was performed using the first polishing tape T1 with an average particle diameter of 30 μm, and an example illustrated in (D) of FIG. 6 is an example in which the first polishing step was performed using the first polishing tape T1 with an average particle diameter of 30 μm and then the second polishing step was performed using the second polishing tape T2 with an average particle diameter of 3 μm. Moreover, (E) of FIG. 6 shows an example in which the mirror-finishing is performed using a polishing tape with an average particle diameter of 1 μm and (F) of FIG. 6 shows an example in which the polishing was randomly performed not only in the circumferential direction but also in the longitudinal direction or the diagonal direction. In the examples illustrated in (A) to (F) of FIG. 6, the polishing was performed under the conditions that the polishing speed and the polishing pressure were the same. Also in the examples illustrated in FIG. 6, similar to the example illustrated in FIG. 5, it can be seen that the chevron-shaped surface cross section is provided in the longitudinal direction as illustrated in (A) of FIG. 4 only in the first polishing step using the first polishing tape T1, whereas the plateau-shaped surface cross section in the longitudinal direction is capable of being formed as illustrated in (B) of FIG. 4 by performing the second polishing step using the second polishing tape T2 after the first polishing step. In addition, in (A) to (D) of FIG. 6, it can be seen that the grooves disposed around in the circumferential direction are formed. However, in (F) of FIG. 6, it can be seen that the grooves are formed in the diagonal direction (spiral shape).

Moreover, the load length ratio (tp) defined in JIS B0601: 1994, and the number of one-point arrival times were measured regarding the test examples illustrated in (B) and (D) to (F) of FIG. 6, and a test example (G) in which the second polishing step was performed using the second polishing tape T2 with an average particle diameter of 3 μm after the first polishing step was performed using the first polishing tape T1 with an average particle diameter of 80 μm. FIG. 7 is a graph obtained by plotting a relationship between the load length ratio (tp) (unit: %) and the number of one-point arrival times (unit: 10,000 times) in the test examples (B), (D) to (F), and (G).

The number of one-point arrival times indicates how many tens of thousands of times the sliding operation was performed until the lubricating oil leaked to the outside between the sliding members. As illustrated in FIG. 7, in the mirror-finished test example (E), the load length ratio (tp) is about 0%, which is the lowest, and the number of one-point arrival times is also as low as about 1 million times. In addition, in the test example (D) in which the second polishing step was performed using the second polishing tape T2 having a whetstone of 3 μm after the first polishing step was performed using the first polishing tape T1 having a whetstone with an average particle diameter of 30 μm, the load length ratio (tp) is slightly less than 20%, but the number of one-point arrival times is as low as about 1 million times, similar to the test example (E) subjected to the mirror-finishing.

On the other hand, in the test example (G) in which the second polishing step was performed with the second polishing tape T2 having a whetstone of 3 μm after the first polishing step was performed with the first polishing tape T1 having a whetstone of 80 μm, the load length ratio (tp) is about 60%, and the number of one-point arrival times is as high as about 10 million times. Similarly, in the test example (B) in which the second polishing step was performed with the second polishing tape T2 having a whetstone of 3 μm after the first polishing step was performed with the first polishing tape T1 having a whetstone of 60 μm, the load length ratio (tp) is about 70%, and the number of one-point arrival times is also as high as about 10 million times. In this way, it is found that there is a certain correlation between the load length ratio (tp) of the sliding member and the number of one-point arrival times, and it can be seen that there is a tendency in which the larger the load length ratio (tp)s, the larger the number of one-point arrival times is. In the test example (F) in which the polishing was performed in the longitudinal direction and the diagonal direction, the load length ratio (tp) is as high as nearly 100%, but the number of one-point arrival times is approximately the same as those of the test examples (G) and (B). It is considered that this is because, in the test example (F), the grooves are also formed in the longitudinal direction and the diagonal direction, and thus the lubricating oil is likely to leak along the grooves even when the load length ratio (tp) is high.

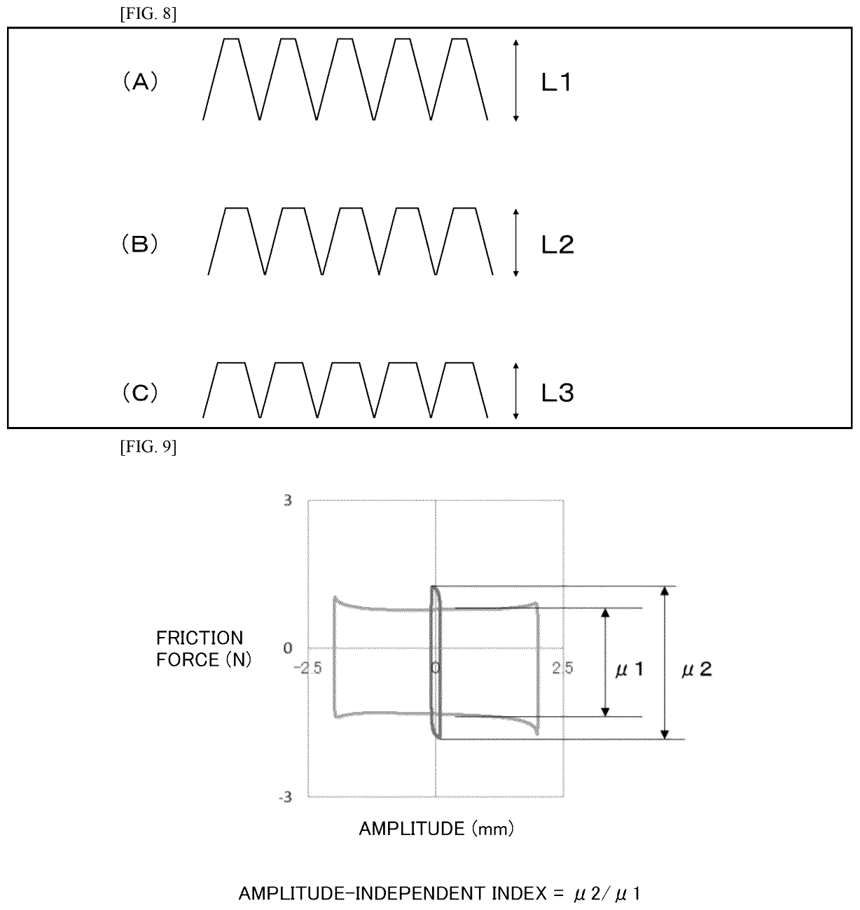

Moreover, how polishing the piston rod of the shock absorber for the vehicle by the polishing method according to the present embodiment influences the ride comfort of the vehicle was investigated. Specifically, as illustrated in (A) to (C) of FIG. 8, in the polishing method according to the present embodiment, changes in ride comfort were measured in a case where polishing conditions such as the size of the average particle diameter of the whetstone included in the first polishing tape T1, the average particle diameter of the whetstone of the second polishing tape T2, and the polishing speed, the polishing pressure, the polishing time, and the like in the first and second polishing steps were changed and the plateau shape of the surface cross section of the piston rod such as the load length ratio (tp) was changed. In the present examples, as illustrated in FIG. 9, in a case where the friction coefficient at a minute amplitude is represented as μ2 and the friction coefficient at the normal amplitude is represented as μ1, an amplitude-dependent index, which is a ratio (μ2/μ1) of the friction coefficient μ1 at the normal amplitude and the friction coefficient μ2 at the minute amplitude, is used as an index indicating the ride comfort. As a result, it can be seen that the ride comfort is changed by changing the average particle diameter of the whetstone of the first polishing tape T1 and the average particle diameter of the whetstone of the second polishing tape T2, and the polishing speed, the polishing pressure, the polishing time, and the like in the first polishing step and the second polishing step, and as illustrated in (A) to (C) of FIG. 8, by adjusting the shape of the surface cross section of the piston rod in the longitudinal direction (for example, adjusting the depth of the grooves, the angle of inclination, the cross section length ratio, and the like in the plateau shape). In particular, it can be seen that the load length ratio (tp) in the longitudinal direction of the piston rod has a large influence on the ride comfort. Specifically, it can be seen that there is a tendency in which the higher the load length ratio (tp), the higher the ride comfort is.

As described above, in the method for manufacturing the piston rod (sliding member) according to the present embodiment, the first polishing step of polishing the surface of the piston rod in the circumferential direction of the piston rod by using the first polishing tape T1 having the first whetstone, and the second polishing step of polishing the piston rod polished in the first polishing step, in the circumferential direction of the piston rod, by using the second polishing tape T2 having the second whetstone with a smaller average particle diameter than the first polishing tape T1 are performed. Accordingly, it is possible to manufacture the piston rod having the grooves disposed around the surface of the piston rod in the circumferential direction and having the surface cross section of the piston rod in the longitudinal direction formed in a plateau shape. In this way, since the chevron-shaped irregularities are polished and formed in a plateau shape in the piston rod having the grooves disposed around the surface in the circumferential direction and having the surface cross section in the longitudinal direction formed in a plateau shape, being caught on the irregularities of the mating member is unlikely to occur and the sliding operation is capable of being smoothly performed. Also, since the lubricating oil is accumulated in the grooves disposed around in the circumferential direction even when the piston rod slides, it is possible to suppress the occurrence of the squeeze-out in which the lubricating oil leaks from between the sliding members. Moreover, in the present embodiment, by setting the average particle diameter of the first whetstone to 15 to 100 μm and the average particle diameter of the second whetstone to 0.1 to 12 μm, the squeeze-out of the lubricating oil can be suppressed until the number of one-point arrival times reaches about 10 million times.

Moreover, in the present embodiment, in the first polishing step, the feeding speed of the first polishing tape T1 is set to 1/10 or less of the turning speed of the piston rod, the relative movement speed of the first polishing tape T1 in the longitudinal direction of the piston rod is set to 1/100 or less of the turning speed of the piston rod, and the oscillation of reciprocating the first polishing tape T1 in the longitudinal direction of the piston rod is not performed. Accordingly, as illustrated in FIG. 2, the grooves disposed around in the circumferential direction are capable of being appropriately formed on the surface of the piston rod, and the load length ratio (tp) in the longitudinal direction is capable of being set to 50% or more.

In addition, when the piston rod is polished by the polishing method according to the present embodiment, the ride comfort of a moving object using the shock absorber having the piston rod is capable of being adjusted by adjusting the load length ratio (tp) in the longitudinal direction of the piston rod. Therefore, in the future, it is expected that the ride comfort of the shock absorber will be capable of being appropriately adjusted by the polishing of the piston rod (or the shape of the surface of the piston rod).

As described above, although the preferred embodiment of the present invention has been described, the technical scope of the present invention is not limited to the descriptions of the above embodiment. It is possible to make various changes and improvements to the above-described embodiment, and embodiments in which such changes and improvements have been made are also included in the technical scope of the present invention.

For example, in the above-described embodiment, the piston rod used in the shock absorber has been exemplified as the sliding member. However, the sliding member according to the present invention is not limited to the piston rod of the shock absorber as the sliding member is a member that slides in the presence of the lubricating oil. The present invention is applicable to various parts that perform the sliding operation, such as piston and actuator parts for hydraulic pumps and hydraulic motors. In addition, the “lubricating oil” according to the present invention may include not only oil having a function of lubricating the sliding operation of the sliding member but also oil having a function of transmitting power such as hydraulic oil of hydraulic equipment.

In addition, the “polishing tape” according to the present invention may include those commercially available as polishing films. In addition, as the polishing tape according to the present invention, both a wrapping tape and a finishing tape are capable of being used. However, it is preferable to use the finishing tape as the first polishing tape Tl and the wrapping tape as the second polishing tape.

### REFERENCE SIGNS LIST

1: tape polishing device
   11: feeding motor
   12: feeding port
   13: roller
   14: winding port
   15: winding motor
2: lathe
T: polishing tape
   T1: first polishing tape
   T2: second polishing tape
O: piston rod

1-12. (canceled)

13. A method for manufacturing a shock absorber sliding member that performs a sliding operation in a presence of a lubricating oil,
the shock absorber sliding member is a tubular rod, the method comprising:
a first polishing step of polishing an outer peripheral surface of the rod in a circumferential direction of the rod by using a polishing tape having a first whetstone to form a plurality of grooves disposed around on the rod in the circumferential direction; and
a second polishing step of polishing the rod after the first polishing step to form an outer peripheral surface cross section in a longitudinal direction of the rod in a plateau shape,
wherein in the first polishing step, the polishing tape is fed while the rod is turned, and the polishing tape is brought into contact with the rod to polish the rod, and
a feeding speed of the polishing tape is 1/10 or less of a turning speed of the rod.

14. The method for manufacturing a shock absorber sliding member according to claim 13,
wherein an average particle diameter of the first whetstone is 15 to 100 μm.

15. The method for manufacturing a shock absorber sliding member according to claim 13,
wherein in the second polishing step, the rod is polished in the circumferential direction by using a polishing tape having a second whetstone with a smaller average particle diameter than the first whetstone.

16. The method for manufacturing a shock absorber sliding member according to claim 15,
wherein an average particle diameter of the second whetstone is 0.1 to 12 μm.

17. The method for manufacturing a shock absorber sliding member according claim 13,
wherein in the first polishing step, the polishing tape is fed while the rod is turned, and the polishing tape is brought into contact with the rod to polish the rod, and
a relative movement speed between the rod and the polishing tape in the longitudinal direction of the rod is 1/100 or less of a turning speed of the rod.

18. The method for manufacturing a shock absorber sliding member according to claim 13,
wherein in the first polishing step, oscillation of reciprocating the polishing tape in the longitudinal direction of the rod is not performed.

19. A method for manufacturing a shock absorber,
wherein a shock absorber sliding member of a shock absorber is manufactured using the method for manufacturing a shock absorber sliding member according to claim 13.

20. A shock absorber sliding member that is a cylindrical rod that performs a sliding operation in a presence of a lubricating oil,
wherein a plurality of grooves disposed around in a circumferential direction is are provided on a surface of the rod,
a surface cross section in a longitudinal direction of the rod is formed in a plateau shape, and
a load length ratio (tp) in the longitudinal direction is 50% or more.

21. A shock absorber comprising:
the shock absorber sliding member according to claim 20.

22. A method for adjusting ride comfort comprising,
when a shock absorber sliding member used for a shock absorber of a moving object is polished,
polishing the shock absorber sliding member such that a surface cross section in a longitudinal direction has a plateau shape; and
adjusting a load length ratio (tp) in the longitudinal direction to adjust a ride comfort of the moving object using the shock absorber.
